(19) United States
(12) Patent Application Publication
(10) Pub. No.: US 2024/0331018 A1
(43) Pub. Date: Oct. 3, 2024

(54) Artificial Intelligence Messaging System

(71) Applicant: James Parrish, Moultonborough, NH (US)

(72) Inventor: James Parrish, Moultonborough, NH (US)

(21) Appl. No.: 18/191,929

(22) Filed: Mar. 29, 2023

(51) Int. Cl. G06Q 30/0601; H04L 51/02

(52) U.S. Cl. CPC G06Q 30/0641; H04L 51/02

(57) ABSTRACT

An artificial intelligence messaging system utilizes a computing device in electronic communication with a chatbot operable on a primary server. The chatbot and/or the primary server are operable to communicate with a secondary server to facilitate the purchase of goods and/or services through the use of an application programming interface. The resulting system enables the fast and efficient purchasing of goods and/or services through the computing device of an end user.

### BACKGROUND OF THE INVENTION

The present disclosure relates generally to an artificial intelligence (“AI”) messaging system. More particularly, the present disclosure relates to a computer system providing integrated access to Internet applications through an AI text-messaging interface.

Purchasing goods or services online has become common place in the modern digital age. Online websites and platforms make purchasing extremely convenient. For most ordering websites, all users are required to do is use a search function on the website to find a desired good or service. The user is then typically prompted to add the desired good or service to a digital cart where the selected good and/or service is saved until the user is ready to complete the purchase. At checkout, users merely input their desired payment information and a delivery address and then confirm their purchase.

This process is typical for everyday household items, electronics, and other common physical goods. However, for more complex services, such as purchasing tickets for sports events, concerts, and air travel, customers typically employ the use of various websites to help them compare and ultimately choose the best priced option, while also considering location, time, and seating.

While the aforementioned methods are incredibly convenient for customers, advances in computer technology have enabled the development of other even more convenient methods of purchasing goods or services. However, there are still a number of problems with recently developed computer technology. There are also a potentially endless number of solutions to these problems. Therefore, what is needed is an AI messaging system having all of the further described features and advantages.

### SUMMARY OF THE INVENTION

The subject matter of this application may involve, in some cases, interrelated products, alternative solutions to a particular problem, and/or a plurality of different uses of a single system or article.

In one aspect, a system is disclosed. In this aspect the system includes a computing device, and the computing device has a processor, a memory, and a graphical user interface. The computing device is in electronic communication with a chatbot, and the chatbot is located on a primary server. The chatbot is operable to communicate with a secondary server through an application programming interface.

In another aspect, a method is disclosed. In this aspect, the method involves a number of steps. The steps include sending a message from a computing device to a chatbot operable on a primary server. The chatbot receives the message input, and the chatbot then outputs a first message response. The primary server containing the chatbot then sends a request through an application programming interface to a secondary server, and the primary server then receives a response through the application programming interface. The chatbot also outputs a second message response, and requests confirmation for the purchase of a good or a service.

### BRIEF DESCRIPTION OF DRAWINGS

FIG. 1 provides a diagrammatic representation of one embodiment of the AI messaging system.

FIG. 2 provides a flowchart representation of one embodiment of the steps performed by a user to operate the system.

FIG. 3 provides a flowchart representation of one embodiment of the steps performed by the system in response to external inputs.

FIG. 4 provides a perspective view of one embodiment of a graphical user interface according to the present disclosure.

FIG. 5 provides a perspective view of another embodiment of a graphical user interface according to the present disclosure.

FIG. 6 provides a perspective view of yet another embodiment of a graphical user interface according to the present disclosure.

### DETAILED DESCRIPTION OF THE INVENTION

The detailed description set forth below in connection with the appended drawings is intended as a description of presently preferred embodiments of the invention and does not represent the only forms in which the present disclosure may be constructed and/or utilized. The description sets forth the functions and/or the sequence of steps for constructing and operating the invention in connection with the illustrated embodiments.

Generally, the present disclosure concerns an AI messaging system. Specifically, the messaging system is a computer system that provides users with integrated access to Internet applications through an AI messaging interface. The messaging system may provide users a convenient method of purchasing goods and/or services, including, but not limited to meals, convenience items, retail items, alcohol, groceries, and sports, concert, and flight tickets.

In one embodiment, the system may include a non-transitory computer readable medium having instructions allowing and instructing a central processing unit (“CPU” or “processor”) to carry out the steps required during messaging, as described herein. This non-transitory computer readable medium may be stored within a housing of a computing device, or may be accessible through an electronic communication systems, such as a network. When used herein the term “computing device” means any electronic device having a processor, memory, and a graphical user interface (“GUI”) display, including, but not limited to, a cellular phone, a tablet, a laptop, or a desktop. Also, when used herein the term “network” refers to any system of interconnected electronic devices, such as, a cellular communication network or the Internet. Connections in the network may be wired or wireless.

In most embodiments, the AI messaging system may require users to log in to a computerized and networked platform that prompts users to create a profile, which may include, creating a username and password, and providing the system with contact information and a preferred payment method. The messaging system may then allow users to purchase goods and/or services by simply sending a message to a chatbot. Messages may be sent using a short message service (“SMS”), the internet, or other similar methods of remote communication. In some embodiments, the AI messaging system is “ungated,” which means no initial login or password information is required before users may communicate with the chatbot. Regardless of the embodiment, once a message is received, the chatbot may request more information from the user before having the user confirm their purchase. Once a purchase is confirmed, the chatbot may output a payment link for the user to complete payment. In some embodiments to facilitate easier purchasing, a user may be able to deposit funds into a digital wallet, thus generating a credit balance. The system may have access to the credit balance and allow users to confirm purchases without generating directing them to payment link.

The messaging system disclosed herein unexpectedly solves a number of problems in the relevant field of art. Aside from being incredibly convenient for users by dramatically speeding up the online purchasing process, the AI messaging system also communicates with external websites and/or servers through various application programming interfaces (“APIs”). For example, when purchasing different goods and/or services from different websites, the messaging system may utilize one or more APIs to perform all the required steps up to purchase confirmation (e.g., selecting a desired item, adding the desired item to a cart, proceeding to checkout, etc.).

An API is a mechanism that enables two software components to communicate with each other using a set of definitions and protocols. While APIs bring many benefits, adoption of API technology can often require a complete overhaul of a computerized system's internal data management, security, and standards of communication. The messaging system solves this problem by providing an artificially intelligent chatbot capable of independently communicating with the APIs.

The artificial intelligence of the messaging system provides another example of an unexpected solution to an identifiable problem. One of the problems with chatbots are that they are unable to adapt their language to match that of humans. One of the potential reasons for this is that chatbots operate using a finite set of data that determines automated responses to common prompts. In order to solve this problem, the AI component of the disclosed messaging interface may save user messages and utilize the stored information to predict future preferences based on users' ordering patterns. Through machine-learning, the AI component may enable the chatbot's responses to flow naturally with human conversation and also predict what suggestions the particular user (s) will be receptive to.

For example, in some embodiments, conversation between the user and the chatbot may be required up to the point of sale. The AI component may facilitate this conversation, by making its conversation with users feel human-like. Similarly, in some embodiments, the AI enabled chatbot may be operable to make suggestions to users about where to purchase goods or services from. Many users do not know what goods or services might be beneficial for them to purchase, so having a human-like chatbot make suggestions that users will be receptive to is also critically important to the functionality of the system.

In some embodiments, the system may utilize a third-party service in addition to one or more APIs to fulfill a user's request for goods. For example, in one embodiment, the system may be operable to save and reorder food items from the websites of various restaurants and/or grocery stores. In another embodiment, the system may be operable to sort tickets for sports and concert events by price. The system may also be able to purchase marijuana from a dispensary. In yet another embodiment, the system may be operable to search for physical stores near a user by accessing location data stored on a user's computing device.

In other embodiments, the system may be able to fulfill a user's request for services. For example, in one embodiment, the system may be operable to make hotel and restaurant reservations. In yet another embodiment, the system may be operable to subscribe to an online service. The system may also make appointments on behalf of the user. In one embodiment, the system may even be operable to access the contact information of individuals stored in the memory of a user's computing device to purchase goods, services, or make appointments with said individuals.

The system may also be operable to purchase goods and/or services from establishments where a user's computing device is located. For example, in one embodiment, the system may be operable to scan a QR code and initiate a conversation with the chatbot for the purchase of goods and/or services in the physical establishment where the user's computing device is located. This embodiment could be used in any number of physical establishments, including, but not limited to, restaurants, hotels, coffee shops, and bars.

In some embodiments, the AI component may enable the system to be operable to offer the best result for flights in a first message to the user. The AI component may rely on user data and machine learning methods to determine a user's favorite airline and preferred seating arrangement. Similarly, the AI component may enable the system to be operable to offer the best results for sports and/or concert tickets. The AI component may rely on user data and machine learning methods to determine a user's preferred price range and ticket quality.

The AI component may also enable users to use slang or shortcuts when referring to the names of businesses or the desired good and/or service to be purchased. The system's handling of shortcuts may include, but is not limited to, the handling of shortcuts for individual users, shortcuts for recipe ordering, shortcuts for users requesting information about a category, and shortcuts for ordering at a specific time in addition to from a specific location and/or website.

In one embodiment, the system may also be able to cross-sell services, for example, by tracking real time data on the location of a user's cellular phone. The system may also by able to customize the speed at which an order is fulfilled and also send push notifications to a user's computing device. The push notifications may concern discounts and previously ordered items.

Turning now to FIG. 1, a diagrammatic representation of one embodiment of the system 1 is shown. In this embodiment, a computing device 2 facilitates user access to the system 1. The computing device 2 includes a GUI 3, a processor 4, and a memory 5. The computing device 2 is operable via programming instructions stored in the memory 5 that are executable by the processor 4. For example, in this embodiment, a user initially interfaces with the system 1 by logging on 6 to a website over a wireless network 7. The files and information that allow the website to function are stored on a primary server 8 in a database 9. Said files and information saved in the database 9 include, but are not limited to, saved information regarding system users. An automatic messaging system or chatbot 10 is in communication with the database 9. Files and information that allow the chatbot 10 to function are also stored on the primary server 8.

A user may communicate with the chatbot 10 by typing a message on the GUI 3 of the computing device 2 and subsequently send that message to the chatbot 10. The sent message provides the initial input 11 for the chatbot 10 to process. In this embodiment, the chatbot 10 initially processes the input 11 through a prompt manager 12, and a message generator 13 helps the chatbot 10 respond with the determined output 14. The chatbot 10 is also configured to save 15 interactions or conversations with computing device(s) 2 in the database 9. By doing this, the chatbot 10 is able to use information gathered in past conversations to improve future performance.

The chatbot 10 is also configured to interact or communicate with an external website through an API 16. The API allows the chatbot 10 to communicate with websites stored on external or secondary servers 17. The API 16 does this by receiving a request 18 from the chatbot 10 on the primary or client server 8. The API 16 then communicates the request to the secondary server 17, which, in this embodiment, also contains website files in a database 19. The secondary server 17 then sends a response 20, which is communicated by the API 16 to the chatbot 10 within the client server 8.

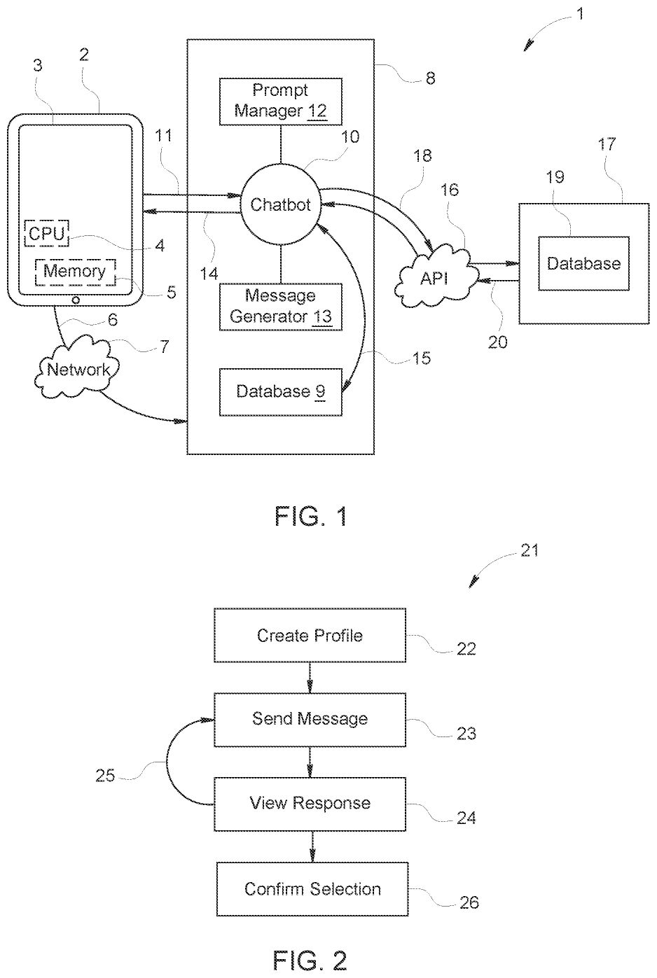

For end users, the system 1 provides a convenient interface to purchase goods and services. FIG. 2 provides a flowchart representation of one embodiment of the steps 21 performed by a user to operate the system 1. First, the user signs up and creates a profile 22 so their information is already stored in the database 9. The step of creating a profile may include, creating a username and password, and providing the system with contact information and a preferred payment method. Once signed up with the system 1, users can then send a message 23 to the chatbot 10. Depending on the computing device 2 used to the send the message 23, the message may be sent using via SMS, the internet, or a cellular communication network. Essentially, the chatbot may be configured to receive messages sent via an internet application in addition to text messages.

Once the message is sent to the chatbot 10, the chatbot is operable to respond 14, and the user can then view the response 24. In some cases, the chatbot 10 may require more information from the user in order to determine which API 16 to send a request 18 to. In these cases, the user may perform the additional step of repeating 25 the steps of sending a message 23 to and viewing a response 24 from the chatbot 10. Once the chatbot 10 determines the correct API 16 to send a request 18 to, the user may be prompted to confirm their selection 26 of goods and services for purchase.

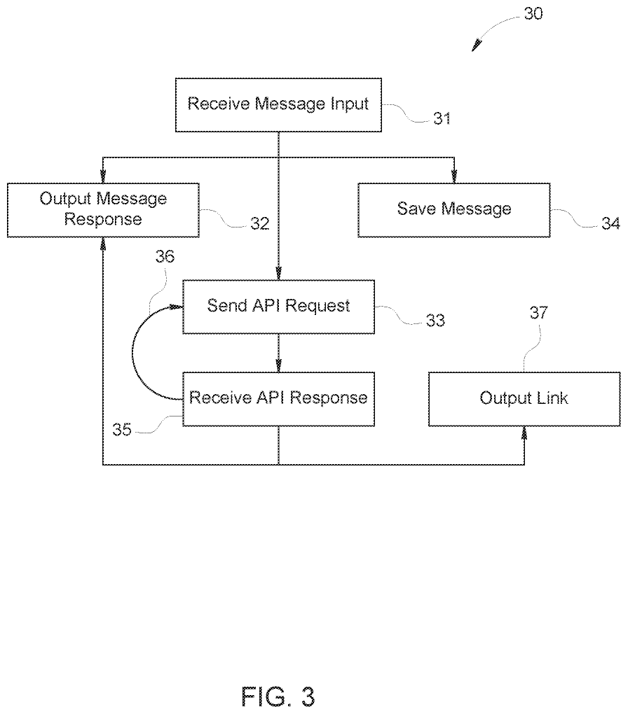

As the user is performing the steps 21, the system 1 also performs a corresponding series of steps 30. FIG. 3 provides a flowchart representation of one embodiment of the steps 30 performed by the system 1 in response to external inputs from a user. In this embodiment, the system 1 is operable to perform these steps by at least one processor. Several components of the system 1 are operable to receive a message input 31. For example, the computing device 2 provides the initial interface for users to input messages. However, the chatbot 10 also receives a user message input 31 once the user performs the step of sending the message 23 to the chatbot 10.

Once the chatbot 10 receives a message input 31, the chatbot 10 is operable to alternatively or simultaneously perform several steps. For example, the chatbot 10 is operable to output a message response 32, and if the received message input provided sufficient information, the chatbot 10 is also operable to send an API request 33. Regardless of the received message input, the chatbot 10 is also operable to save messages 34 for future reference. Such messages may be saved in a database 9 in association with a profile of a specific user. This stored message data may then be used by the chatbot 10 to learn preferences and communication methods of the specific user to optimize future performance.

After the chatbot 10 sends an API request 33, the chatbot 10, as the client, will receive an API response 35 from a server. If necessary, the chatbot 10 and the server will repeat 36 the communication process until the chatbot 10 determines that the user's request has been satisfied. The chatbot 10 will then output a second message response 32 containing appropriate information in response to the received message input. This second message response may request confirmation from the user, and, once the user makes the requested confirmation 26, the chatbot 10 will then output a link 37 to a website operated on the server the chatbot 10 was communicating with.

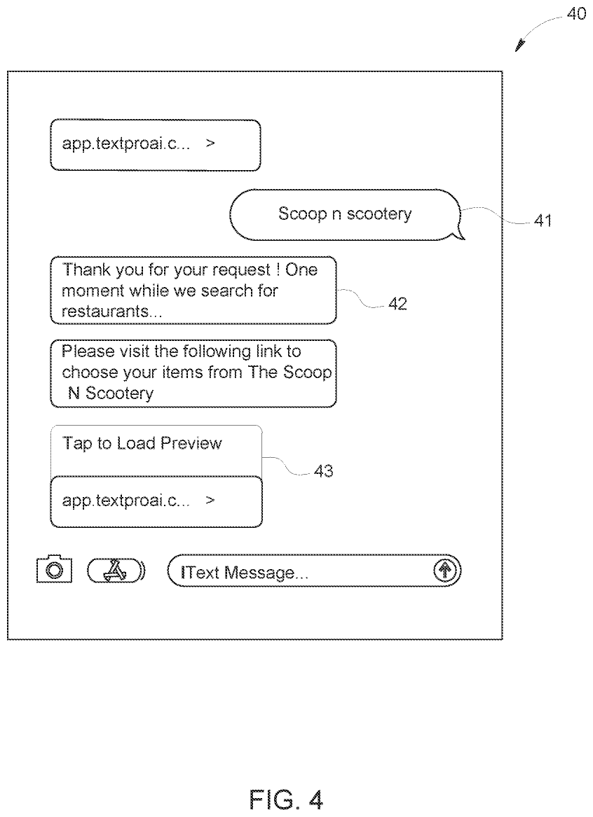

The GUI of the computing device 2 is operable to display the message inputs of the user and the message outputs of the chatbot 10. FIGS. 4-6 provide perspective views of different embodiments GUIs depending on both the received message input from the user and the functionality of the chatbot 10. For example, FIG. 4 provides a perspective view of a GUI 40 where the initial message request 41 from the user is a new good and/or service provider, such as a restaurant. When the term “new” is used in this context, the term refers to a good and/or service provider that the requesting user has not ordered from before. The GUI 40 also displays an automatic response 42 from the chatbot 10, as well as a link 43 to the new good and/or service provider's website.

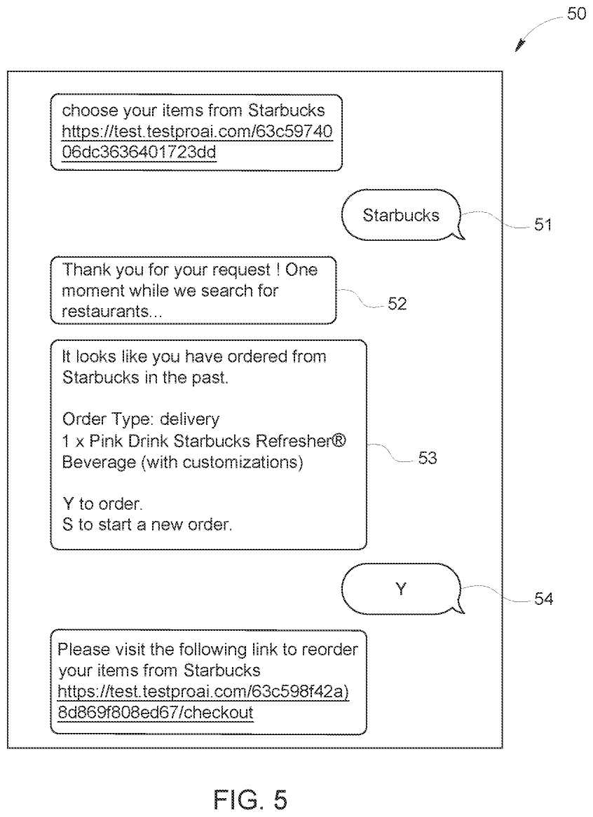

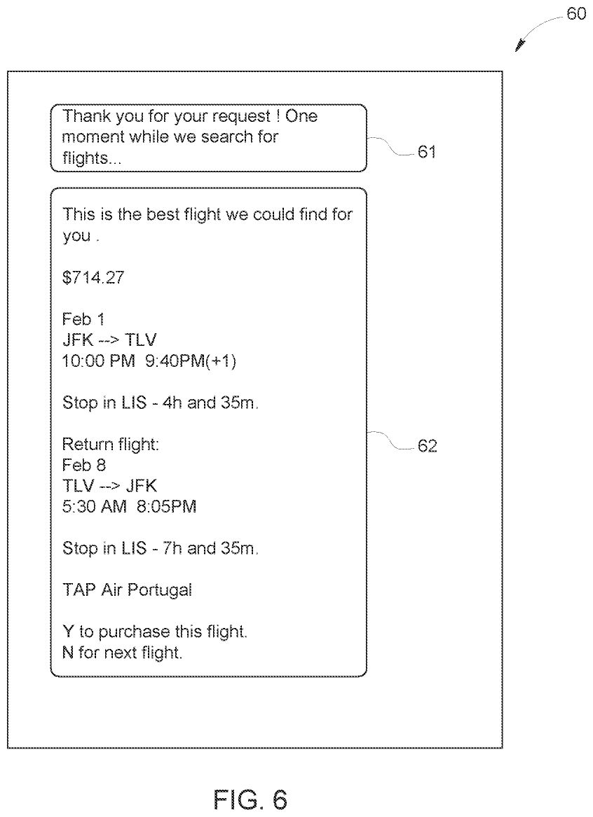

In another embodiment, shown in FIG. 5, a GUI 50 displays an initial message 51 for an existing good and/or service provider, such as a coffee shop. When the term “existing” is used in this context, the term refers to a good and/or service provider that the requesting user has ordered from before. The GUI 50 also displays an automatic response 52 and a reorder initiation response 53 from the chatbot 10. In this embodiment, the reorder initiation response 53 requests a confirmation 54 from the user.

In yet another embodiment, shown in FIG. 6, a GUI 60 displays an automatic response 61 and the results of a search 62 performed for a best priced good and/or service from various providers, including, but not limited to, airlines. In this embodiment, the search results 62 display a price for the requested tickets and a time associated with departure and arrival. Once confirmed, the purchase of tickets in this embodiment may be completed through a single link generated by an API.

While several variations of the present disclosure have been illustrated by way of example in preferred or particular embodiments, it is apparent that further embodiments could be developed within the spirit and scope of the present disclosure, or the inventive concept thereof. However, it is to be expressly understood that such modifications and adaptations are within the spirit and scope of the present disclosure, and are inclusive, but not limited to the following appended claims as set forth.

What is claimed is:

1. A system comprising:
a computing device, the computing device comprising a processor, a memory, and a graphical user interface;
wherein the computing device is in electronic communication with a chatbot operable on a primary server;
wherein the chatbot is operable to communicate with a secondary server through an application programming interface.

2. The system of claim 1 further comprising a prompt manager in communication with the chatbot.

3. The system of claim 1 further comprising a message generator in communication with the chatbot.

4. The system of claim 1 wherein the chatbot is operable to save a plurality of message data in a database.

5. The system of claim 4 wherein the database is operable on the primary server.

6. The system of claim 1 wherein the computing device is in electronic communication with the chatbot through a short message service.

7. The system of claim 1 wherein the computing device is in electronic communication with the chatbot through a network.

8. The system of claim 1 wherein the application programming interface is operable to receive a request from the chatbot.

9. The system of claim 1 wherein the application programming interface is operable to receive a response from the secondary server.

10. The system of claim 1 wherein the computing device is operable to input a message request to purchase a good or a service.

11. The system of claim 1 wherein the chatbot is operable to output a message response requesting a confirmation to purchase a good or a service.

12. The system of claim 1 wherein the graphical user interface is operable to display an initial message for a purchase of a good or a service from a new provider.

13. The system of claim 1 wherein the graphical user interface is operable to display an initial message for a purchase of a good or a service from an existing provider.

14. The system of claim 1 wherein the graphical user interface is operable to display a single link for purchase of a good or service.

15. The system of claim 14 wherein the single link is generated by the application programming interface.

16. A method, the method comprising a plurality of steps of:
sending a message from a computing device to a chatbot operable on a primary server;
receiving a message input from the message outputting a first message response by the chatbot; and
sending a request through an application programming interface by the primary server to a secondary server;
receiving a response through an application programming interface by the primary server; and
outputting a second message response by the chatbot, the chatbot requesting a confirmation for a purchase of a good or a service.

17. The method of claim 16 further comprising the step of receiving the second output message response by the computing device.

18. The method of claim 16 further comprising the step of saving the received message input in a database by the chatbot.

19. The method of claim 16 further comprising the step of outputting a link for payment by the chatbot.

20. The method of claim 16 further comprising the step of sending the confirmation for the purchase of the good or service by the computing device.
